(19) United States
(12) Patent Application Publication
(10) Pub. No.: US 2008/0042600 A1
(43) Pub. Date: Feb. 21, 2008

(54) Display Apparatus and Method for Driving the Same

(76) Inventors: Toru Teraoka, Kawasaki (JP); Akihiro Takagi, Kawasaki (JP)

Correspondence Address: MCDERMOTT WILL & EMERY LLP, 600 13TH STREET, N.W., WASHINGTON, DC, 20005-3096, US

(21) Appl. No.: 11/791,792

(22) PCT Filed: Nov. 29, 2005
(86) PCT No.: PCT/JP05/21904

§ 371 Date: May 29, 2007

(30) Foreign Application Priority Data
Nov. 29, 2004 (JP) 2004-344631

(51) Int. Cl. H05B 37/02

(52) U.S. Cl. 315/307

(57) ABSTRACT

A display apparatus having a capacitive load (Cij), clamp circuits (103, 104) for clamping the potential of the capacitive load to high and low levels, power recovering circuits (103, 104) including coils for recovering power from the capacitive load and supplying the recovered power to the capacitive load, a display load rate determining part (111) for determining a display load rate, and a control part (112) is provided. When the determined display load rate is smaller than a first threshold value, the control part does not use the power recovering circuits but uses the clamp circuits to control the potential of the capacitive load. When the determined display load rate is larger than the first threshold value, the control part uses the power recovering circuits and clamp circuits to control the potential of the capacitive load.

### TECHNICAL FIELD

The present invention relates to a display apparatus and a method for driving the same, and particularly relates to a display apparatus having capacitive loads and a method for driving the same.

### BACKGROUND ART

A plasma display is a large-sized flat display, and has entered widespread use as a household wall-mounted television set. To be put into more widespread use, it is required to have the equivalent luminance as CRT.

Further, in order to reduce power consumption, power recovery circuits are provided in a plasma display. A power recovery circuit itself is widely known, and the disclosures of it are found in, for example, Japanese Patent Application Laid-open No. Shou 63-101897 and Japanese Patent Application Laid-open No. Hei 7-160219. However, a power recovery circuit is an L-C resonant circuit, and therefore, requires the time for recovering power from a plasma display panel, and the time for supplying the recovered power to the plasma display panel. As a result, the sustain pulse width for display becomes wide, and the number of sustain pulses cannot be made large. Therefore, the total number of sustain pulses in one frame is limited, and luminance cannot be increased. Luminance is basically proportional to the number of total sustain pulses.

Further, Japanese Patent Application Laid-open No. 2002-62844 discloses a plasma display using a sustain pulse constituted of a positive potential and a negative potential.

Patent Document 1: Japanese Patent Application Laid-open No. Shou 63-101897

Patent Document 2: Japanese Patent Application Laid-open No. Hei 7-160219

Patent Document 3: Japanese Patent Application Laid-open No. 2002-62844

### SUMMARY OF THE INVENTION

In recent years, enhancement in light-emission luminance, especially enhancement in peak luminance has been demanded of a plasma display.

An object of the present invention is to provide a display apparatus capable of enhancing luminance in a region with a relatively low display load rate, and a method for driving the same.

According to one aspect of the present invention, a display apparatus having a capacitive load, clamp circuits which are for clamping a potential of the capacitive load to a high level and a low level, power recovering circuits including coils which are for recovering power from the capacitive load and supplying the recovered power to the capacitive load, a display load rate determining part for determining a display load rate, and a control part is provided. When the determined display load rate is smaller than a first threshold value, the control part does not use the power recovering circuits but controls the potential of the capacitive load by the clamp circuits, and when the determined display load rate is larger than the first threshold value, the control part controls the potential of the capacitive load by the power recovering circuits and the clamp circuits.

### BRIEF DESCRIPTION OF THE DRAWINGS

FIG. 1 is a diagram showing a basic configuration example of a plasma display (display apparatus) according to a first embodiment of the present invention;

FIG. 2A is a view showing a sectional configuration example of a display cell;

FIG. 2B is a view showing a sectional configuration example of the display cell;

FIG. 2C is a view showing a sectional configuration example of the display cell;

FIG. 3 is a diagram showing a configuration example of one frame of an image;

FIG. 4 is a circuit diagram showing a configuration example of a Y electrode drive circuit according to the first embodiment;

FIG. 5A is a timing chart showing a sustain pulse of a Y electrode when a display load rate is large according to the first embodiment;

FIG. 5B is a timing chart showing the sustain pulse of the Y electrode when the display load rate is small according to the first embodiment;

FIG. 6A is a timing chart showing a sustain pulse of the Y electrode when the display load rate is large according to a second embodiment of the present invention;

FIG. 6B is a timing chart showing the sustain pulse of the Y electrode when the display load rate is small according to the second embodiment;

FIG. 7 is a graph showing relationship of the display load rate and the total number of sustain pulses according to a third embodiment of the present invention; and

FIG. 8 is a graph showing relationship of the display load rate, the total power consumption and the total number of sustain pulses according to a fourth embodiment of the present invention.

### DETAILED DESCRIPTION OF THE PREFERRED EMBODIMENTS

### First Embodiment

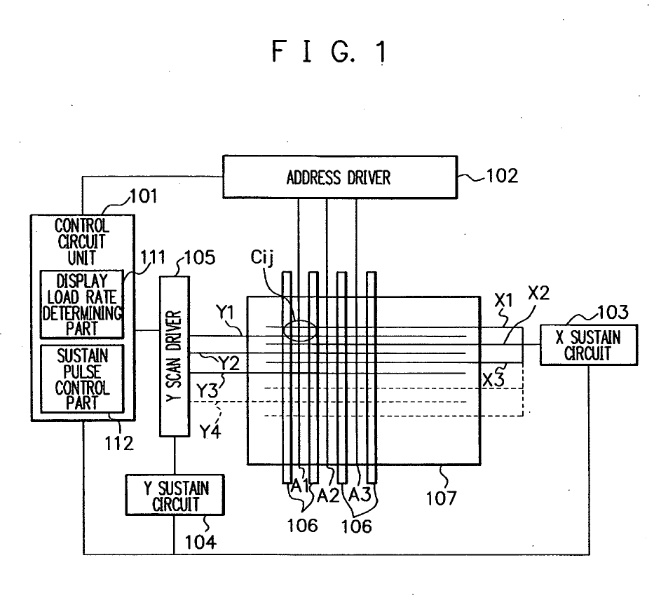

FIG. 1 is a diagram showing a basic configuration example of a plasma display (display apparatus) according to a first embodiment of the present invention. A control circuit unit 101 has a display load rate determining part 111 and a sustain pulse control part 112, and controls an address driver 102, an X sustain circuit 103 which drives X electrodes, a Y sustain circuit 104 which drives Y electrodes, and a scan driver 105.

The address driver 102 supplies a predetermined voltage to address electrodes A1, A2, A3, . . . . Hereinafter, each of the address electrodes A1, A2, A3, . . . or the generic name of them will be called an address electrode Aj, and j means a subscript.

The scan driver 105 supplies a predetermined voltage to Y electrodes Y1, Y2, Y3, . . . in correspondence to the control of the control circuit unit 101 and the Y sustain circuit 104. Hereinafter, each of the Y electrodes Y1, Y2, Y3, . . . or the generic name of them will be called a Y electrode Yi, and i means a subscript.

The X sustain circuit 103 supplies the same voltage to the X electrodes X1, X2, X3, . . . , respectively. Hereinafter, each of the X electrodes X1, X2, X3, . . . or the generic name of them will be called an X electrode Xi, and i means a subscript. The respective X electrodes Xi are connected to each other and has the same voltage level.

In a display region 107, the Y electrodes Yi and the X electrodes Xi form rows extending in parallel in the horizontal direction, and the address electrodes Aj form columns extending in the vertical direction. The Y electrodes Yi and the X electrodes Xi alternately disposed in the vertical direction. Ribs 106 have a stripe rib structure provided between the respective address electrodes Aj.

The Y electrode Yi and the address electrode Aj form a two-dimensional matrix of a row i and a column j. A display cell Cij is formed by an intersection point of the Y electrode Yi and the address electrode Aj, and the X electrode Xi adjacent to the intersection point in correspondence to it. The display cell Cij corresponds to a pixel, and the display region 107 can display a two-dimensional image. The X electrode Xi and the Y electrode Yi in the display cell Cij has a space between them to constitute a capacitive load.

A display load rate determining part 111 inputs therein image data to be displayed in the display region 107 from an outside, and determines a display load rate of one frame image based on the image data. The display load rage is determined based on the number of pixels emitting light and tone values of the pixels emitting light. For example, when all the pixels of one frame image are displayed in the maximum tone value, the display lord rate is 100%. When the all the pixels of one frame image are displayed in ½ of the maximum tone value, the display load rate is 50%. When only a half (50%) of the pixels of one frame image is displayed in the maximum tone value, the display load rate is also 50%.

Further, the display load rate determining part 111 may determine the display load rate based on the sustain current or the sustain power of the X sustain circuit 103 and/or the Y sustain circuit 104. In the light-emitting pixel, discharge occurs in the corresponding display cell Cij and light is emitted. Therefore, by measuring the sustain current that is the discharge current or the sustain power, the display load rate can be also determined.

When the display load rate is large, the image is entirely bright, and when the display load rate is small, the image is entirely dark. When a bright color such as glitter of, for example, a headlight is to be displayed in a dark image, high luminance is required. Further, in a dark image, a remarkable difference between a dark portion and a bright portion, that is, enhancement in contrast is also required.

Further, when the display load rate is large, large sustain power is consumed, and therefore, power consumption is preferably reduced by using a power recovery circuit. On the other hand, when the display load rate is small, consumed sustain power is small. Therefore, power recovery does not necessarily have to be performed, and high luminance and high contrast are more preferably realized.

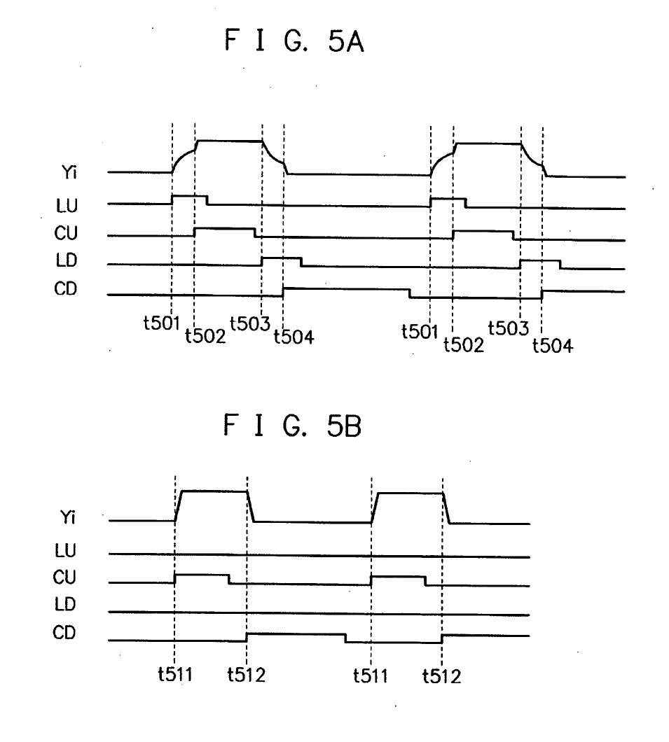

A sustain pulse control part 112 controls the X sustain circuit 103 and the Y sustain circuit 104 in accordance with the display load rate determined by the display load rate determining part 111. In concrete, when the display load rate is smaller than the first threshold value, the power recovery circuits are not used, but a sustain pulse is generated by clamp circuits. When the display load rate is larger than the first threshold value, a sustain pulse is generated by the power recovery circuits and the clamp circuits. The details will be described later with reference to FIGS. 5A and 5B.

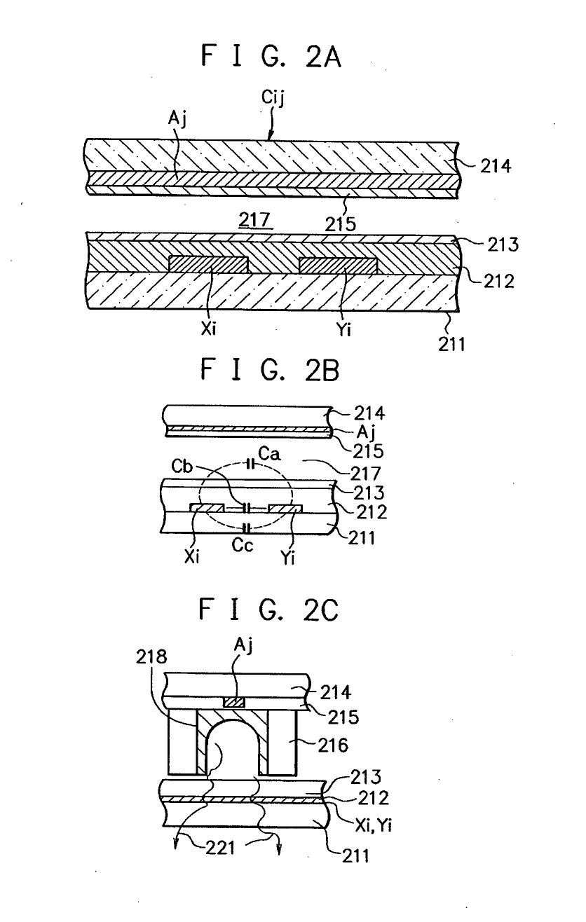

FIG. 2A is a view showing a sectional configuration example of the display cell Cij in FIG. 1. The X electrode Xi and the Y electrode Yi are formed on a front glass substrate 211. A dielectric layer 212 for insulating them against a discharge space 217 is deposited on them, and an MgO (magnesium oxide) protection film 213 is further deposited on the dielectric layer 212.

Meanwhile, the address electrode Aj is formed on a rear glass substrate 214 disposed to be opposed to the front glass substrate 211, a dielectric layer 215 is deposited on the address electrode Aj, and a phosphor is further adhered onto the dielectric layer 215. The phosphor is not directly related to the description of the present invention, and therefore it is not shown and is omitted in FIG. 2A. An Ne+Xe penning gas or the like is sealed in the discharge space 217 between the MgO protection film 213 and the dielectric layer 215.

FIG. 2B is a view for explaining a panel capacitance Cp of an AC driven plasma display. A capacitance Ca is a capacitance of the discharge space 217 between the X electrode Xi and the Y electrode Yi. A capacitance Cb is a capacitance of the dielectric layer 212 between the X electrode Xi and the Y electrode Yi. A capacitance Cc is a capacitance of the front glass substrate 211 between the X electrode Xi and the scanning electrode Yi. The panel capacitance Cp between the electrodes Xi and Yi is decided by the total of these capacitances Ca, Cb and Cc.

FIG. 2C is a view for explaining light emission of the AC driven plasma display. On an inner surface of a rib 216, a red, a blue and a green phosphors 218 are arranged and coated in stripes according to color, and light 221 is generated by exciting the phosphors 218 by discharge between the X electrode Xi and the Y electrode Yi.

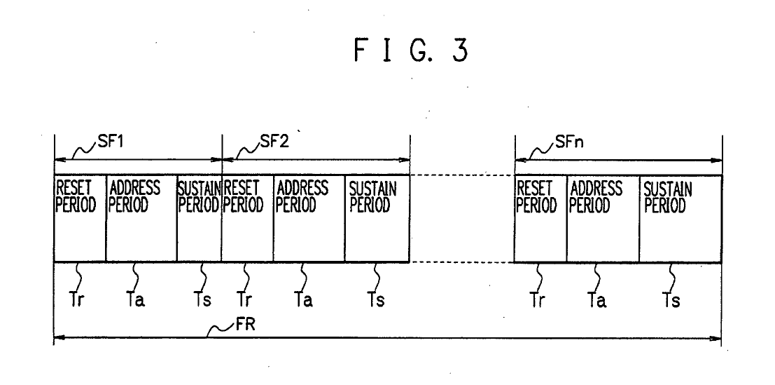

FIG. 3 is a view showing a configuration example of one frame FR of an image. The image is formed at 60 frames/second, for example. The one frame FR is formed by a first sub frame SF1, a second sub frame SF2, . . . and an n^{th} sub frame SFn. The n is, for example, 10, and corresponds to the number of tone bits. Each of the sub frames SF1, SF2 and the like or the generic name of them will be called a sub frame SF hereinafter.

Each sub frame SF is configured by a reset period Tr, an address period Ta, and a sustain (sustain discharge) period Ts. In the reset period Tr, initialization of the display cell is performed. In the address period Ta, light emission or non-emission of each display cell can be selected by an address discharge between the address electrode Aj and the Y electrode Yi. In the sustain period Ts, a sustain discharge is performed between the X electrode Xi and the Y electrode Yi of the selected display cell, and light emission is performed. In each SF, the number of light emissions (length of the sustain period Ts) by the sustain pulse between the X electrode Xi and the Y electrode Yi differs. Thereby, the tone value can be decided.

In this embodiment, a sustain pulse in the sustain period Ts is caused to differ in accordance with the display load rate.

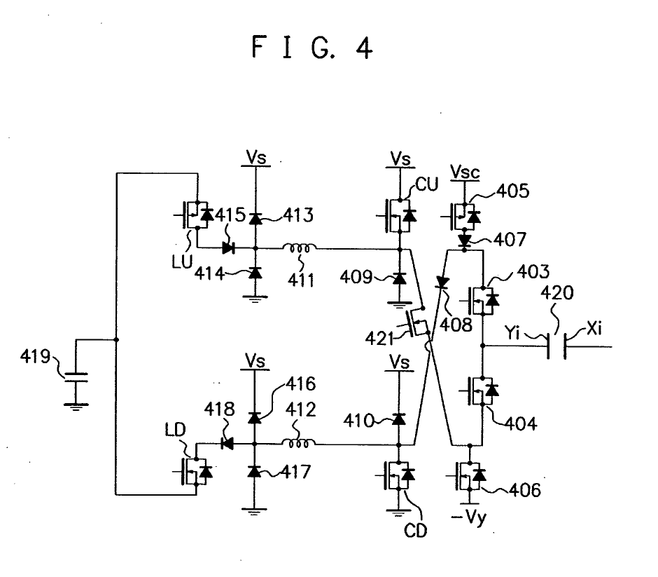

FIG. 4 is a circuit diagram showing a configuration example of a Y electrode drive circuit according to this embodiment. The Y electrode drive circuit corresponds to the Y sustain circuit 104 and the scan driver 105 in FIG. 1. The X electrode Xi and the Y electrode Yi sandwich a space insulator therebetween, and configure a capacitive load (panel capacitance) 420. The circuit which is connected to the left of the Y electrode Yi is the Y electrode drive circuit. An X electrode drive circuit is connected to the right of the X electrode Xi. Hereinafter, the Y electrode drive circuit will be described, and the X electrode drive circuit has the same configuration as the Y electrode drive circuit. However, the X electrode drive circuit corresponds to the X sustain circuit 103 in FIG. 1, and does not have transistors 403 and 404, scan operation elements 405, 406 and 421 and diodes 407 and 408.

First, the circuit corresponding to the Y sustain circuit 104 will be described. The Y sustain circuit 104 includes the clamp circuit for clamping and the power recovery circuit for performing L-C resonance. Hereinafter, an MOS field effect transistor (FET) will be simply called a transistor. A high level clamp circuit has a transistor CU for clamping the potential of the Y electrode Yi of the capacitive load 420 to a high level (for example, Vs). A low level clamp circuit has a transistor CD for clamping the potential of the Y electrode Yi of the capacitive load 420 to a low level (for example, a ground). The power recovery circuit has a coil 412, a diode 418 and a transistor LD for recovering power from the Y electrode Yi of the capacitive load 420, and a coil 411, a diode 415 and a transistor LU for supplying the recovered power to the Y electrode Yi of the capacitive load 420.

An n-channel transistor 403 has a parasitic diode, its drain is connected to an anode of a diode 408, and its source is connected to the Y electrode Yi. An n-channel transistor CD has a parasitic diode, its source is connected to the ground, and its drain is connected to a cathode of the diode 408. A diode 410 has its anode connected to a drain of the transistor CD, and its cathode connected to a positive potential (power potential) Vs. The coil 412 is connected between the cathode of the diode 408 and the anode of the diode 418. A diode 416 has its anode connected to the anode of the diode 418, and its cathode connected to the positive potential Vs. A diode 417 has its anode connected to the ground, and has its cathode connected to the anode of the diode 418. The n-channel transistor LD has a parasitic diode, and has its source connected to a capacitor 419, and its drain connected to the cathode of the diode 418.

The n-channel transistor 404 has a parasitic diode, and has its drain connected to the Y electrode Yi and its source connected to an n-channel transistor 421. The coil 411 is connected between a drain of a transistor 421 and a cathode of the diode 415. The n-channel transistor CU has a parasitic diode, and has its drain connected to the positive potential Vs and its source connected to the drain of the transistor 421. A diode 409 has its cathode connected to the source of the transistor CU and has its anode connected to the ground. A diode 413 has its anode connected to the cathode of the diode 415, and has its cathode connected to the positive potential Vs. A diode 414 has its anode connected to the ground, and has its cathode connected to the cathode of the diode 415. The p-channel transistor LU has a parasitic diode, and has its source connected to the capacitor 419, and its drain-connected to the anode of the diode 415. The capacitor 419 is connected between the sources of the transistors LD and LU and the ground.

Next, the circuit corresponding to the scan driver 105 will be described. A p-channel transistor 405 has a parasitic diode, and has its source connected to a potential Vsc and its drain connected to an anode of a diode 407. A cathode of the diode 407 is connected to the drain of the transistor 403. An n-channel transistor 406 has a parasitic diode, and has its source connected to a negative potential −Vy and its drain connected to the source of the transistor 404.

FIG. 5A is a timing chart showing the sustain pulse of the Y electrode Yi when the display load rate is large, and FIG. 5B is a timing chart showing the sustain pulse of the Y electrode Yi when the display load rate is small. The Y sustain circuit 104 in FIG. 1 generates a sustain pulse shown in FIG. 5A when the display load rate is larger than the first threshold value, and generates a sustain pulse shown in FIG. 5B when the display load rate is smaller than the first threshold value, under the control of the sustain pulse control part 112. The sustain pulses in FIGS. 5A and 5B are generated by the Y sustain circuit in FIG. 4 in the sustain period Ts in FIG. 3.

Referring to FIG. 5A, a method for generating a sustain pulse when the display load rate is large will be described. First, at a time t501, the transistor LU is turned on. The capacitor 419 is charged as will be described later, and therefore, the voltage of the capacitor 419 is supplied to the Y electrode Yi by L-C resonance through the transistors LU, 421 and 404. The potential of the Y electrode Yi rises toward the positive potential Vs.

Next, at a time t502, the transistor CU is turned on. The positive potential Vs is supplied to the Y electrode Yi through the transistors CU, 421 and 404. The Y electrode Yi is clamped to the positive potential Vs. Thereafter, the transistor LU is turned off, and the transistor CU is turned off.

Next, at a time t503, the transistor LD is turned on. The electric charge of the Y electrode Yi is released to the capacitor 419 connected to the ground by L-C resonance through the transistors 403 and LD. The potential of the Y electrode Yi lowers to the ground.

Next, at a time t504, the transistor CD is turned on. The Y electrode Yi is connected to the ground through the transistors 403 and CD. The Y electrode Yi is clamped to the ground. Thereafter, the transistor LD is turned off and the transistor CD is turned off. Thereafter, the operation of the above described times t501 to t504 is repeated.

The sustain pulse of the Y electrode Yi is described above, but the sustain pulse of the X electrode Xi becomes the pulse of the opposite phase from that of the sustain pulse of the Y electrode Yi. Namely, when the sustain pulse of the Y electrode Yi is at the ground, the sustain pulse of the X electrode Xi is at the positive potential VS, and when the sustain pulse of the X electrode Xi is at the ground, the sustain pulse of the Y electrode Yi is at the positive potential Vs.

In the vicinity of the time t502, the voltage Vs is applied between the X electrode Xi and the Y electrode Yi. Sustain discharge for display between the X electrode Xi and the Y electrode Yi occurs in the vicinity of the time t502. Similarly, in the vicinity of the time t504, the voltage Vs is applied between the X electrode Xi and the Y electrode Yi, and a sustain discharge for display occurs between the X electrode Xi and the Y electrode Yi.

As described above, when the display load rate is larger than the first threshold value, the potential of the capacitive load 420 is controlled by the power recovery circuit and the clamp circuit as shown in FIG. 5A. In concrete, when the display load rate is larger than the first threshold value, the power of the capacitive load 420 is recovered from the time t503 to time t504, and the potential of the capacitive load 420 is clamped to the low level (ground) from the time t504 onward. From the time t501 to time t502, the recovered power is supplied to the capacitive load 420, and at the time 502 and onward, the potential of the capacitive load 420 is clamped to the high level Vs. When the display load rate is large, the discharge current is large and the current flowing in all the X and Y sustain circuits is large. Therefore, it is effective to reduce power consumption by using the power recovery circuit.

Next, with reference to FIG. 5B, a method for generating a sustain pulse when the display load rate is small will be described. Since the power recovery circuit is not used, the switching transistors LU and LD of the power recovery circuit are kept off.

First, at a time t511, the transistor CU is turned on. The positive potential Vs is supplied to the Y electrode Yi through the transistors CU, 421 and 404. The Y electrode Yi is clamped to the positive potential Vs. Thereafter, the transistor CU is turned off.

Next, at a time t512, the transistor CD is turned on. The Y electrode Yi is connected to the ground through the transistors 403 and CD. The Y electrode Yi is clamped to the ground. Thereafter, the transistor CD is turned off. Thereafter, the operation of the above described times t511 to t512 is repeated.

The above is the description of the sustain pulse of the Y electrode Yi, and the sustain pulse of the X electrode Xi is the pulse of the opposite phase from that of the sustain pulse of the Y electrode Yi. In the vicinity of the time t511 and in the vicinity of the time t512, the voltage Vs is applied between the X electrode Xi and the Y electrode Yi, and the sustain discharge for display occurs between the X electrode Xi and the Y electrode Yi.

As above, when the display load rate is smaller than the first threshold value, the potential of the capacitive load 420 is controlled by the clamp circuit without using the power recovery circuit as shown in FIG. 5B. In concrete, when the display load rate is smaller than the first threshold value, a pulse is generated by clamping the potential of the capacitive load 420 to the high level Vs or the low level (ground) without performing power recovery of the capacitive load 420.

The sustain pulse of FIG. 5A rises in two steps by the power recovery circuit and the clamp circuit. Therefore, at the time of sustain discharge, power supply to the Y electrode Yi is distributed timewise. Accordingly, if the Y electrode Yi is always driven with the sustain pulse of FIG. 5A irrespective of the display load rate, peak luminance at the maximum tone value when the display load rate is small becomes comparatively low. On the other hand, the sustain pulse of FIG. 5B without power recovery rapidly rises by the clamp circuit. Therefore, at the time of sustain discharge, power supply to the Y electrode Yi concentrates timewise, and the peak luminance at the maximum tone value when the display load rate is small becomes comparatively high. As described above, when the display load rate is small, by generating the sustain pulse of FIG. 5B, the peak luminance at the maximum tone value can be made high, and the difference between the dark part and the bright part becomes relatively large, whereby the contrast is improved, and a headlight and the like in a dark image can be contrasted.

Further, the sustain pulse of FIG. 5A requires the time period from t503 to t504 for recovering the power from the capacitive load 420, and the time period from t501 to t502 for supplying the recovered power to the capacitive load 420. Therefore, a width from t501 to t504 of the sustain pulse becomes large, and it is difficult to increase the number of sustain pulses. On the other hand, the sustain pulse of FIG. 5B does not use the power recovery circuit. Therefore, a width from t511 to t512 of the sustain pulse can be made small, and the number of sustain pulses can be increased. Namely, when the display load rate is smaller than the first threshold value, the frequency of the sustain pulse is made high and the number of sustain pulses is increased, as compared with when the display load rate is larger than the first threshold value, whereby the peak luminance can be made higher. In concrete, when the display load rate is smaller than the first threshold value, the average frequency per one frame image of the sustain pulse for display supplied to the capacitive load 420 is increased, and the number of sustain pulses per one frame image is increased, as compared with the time when the display load rate is larger than the first threshold value.

As described above, according to this embodiment, the effect of enhancing the peak luminance and improving the contrast when the display load rate is small is provided. However, when the average frequency of the sustain pulse and/or the number of pulses are/is to be changed, if a large change is rapidly given simply in accordance with the display load rate, a level difference in luminance occurs by the frame unit at the time of change. Therefore, a viewer feels sense of incompatibility, and an adverse effect is given to the image display quality. Thus, when the average frequency of the sustain pulse for display is changed, it is preferable to change the average frequency and the number of pulses gradually during passage of a plurality of frames. For example, it is preferable to change the average frequency and the number of pulses gradually within the passage of, for example, 60 frames.

According to this embodiment, when the display load rate is small, the magnitude of the discharge current flowing in the entire plasma display panel is not so large, and therefore, in this case, the power recovery circuit is not used, and direct drive from the power supply is performed by the clamp circuit. Thereby, instead of gradual power rise by L-C resonance, a relatively rapid pulse waveform can be obtained, and the pulse width can be narrowed. As a result that the pulse width is narrowed, the total number of pulses contained in a fixed time (for example, within one frame) can be increased, and the flowing current value can be suppressed to such a level that the use of a special protection circuit is not required. Since the total power consumption is relatively small, a special heat release measure is not required. On the other hand, when the display load rate is large, a large discharge current flows in the entire plasma display panel, and therefore, the total power consumption is reduced by using the power recovery circuit.

### Second Embodiment

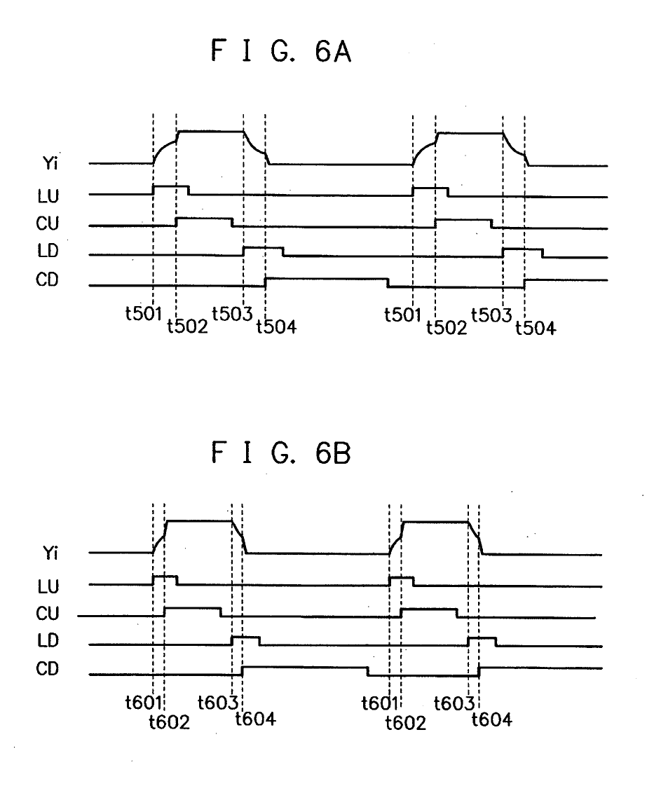

A second embodiment of the present invention will be described. This embodiment generates sustain pulses of FIGS. 6A and 6B instead of the sustain pulses of FIGS. 5A and 5B in the first embodiment.

FIG. 6A is a timing chart showing the sustain pulse of the Y electrode Yi when the display load rate is large, and FIG. 6B is a timing chart showing the sustain pulse of the Y electrode Yi when the display load rate is small. The Y sustain circuit 104 in FIG. 1 generates the sustain pulse shown in FIG. 6A when the display load rate is larger than the first threshold value, and generates the sustain pulse shown in FIG. 6B when the display load rate is smaller than the first threshold value, under the control of the sustain pulse control part 112. The sustain pulses of FIGS. 6A and 6B are generated by the Y sustain circuit in FIG. 4 in the sustain period Ts in FIG. 3.

FIG. 6A shows the sustain pulse when the display load rate is large, which is the same pulse as the sustain pulse of FIG. 5A. Accordingly, the sustain pulse of FIG. 6A can be generated by the same method as the method for generating the sustain pulse of the above described FIG. 5A.

FIG. 6B is the sustain pulse when the display load rate is small. The sustain pulse of FIG. 6B is generated by the power recovery circuit and the clamp circuit as the sustain pulse of FIG. 6A. The times t601 to t604 in FIG. 6B respectively correspond to the times t501 to t504 of FIG. 6A.

The sustain pulse of FIG. 6B is basically the same as the sustain pulse of FIG. 6A, but differs in the timing t602 at which the potential of the capacitive load 420 is clamped to the high level Vs and the timing t604 at which it is clamped to the low level (ground). In concrete, the sustain pulse of FIG. 6B when the display load rate is smaller than the first threshold value advances the timing t602 at which the potential of the capacitive load 420 is clamped to the high level and the timing t604 at which the potential of the capacitive load 420 is clamped to the low level, as compared with the sustain pulse of FIG. 6A when the display load rate is larger than the first threshold value.

Namely, the time period from the time t601 to the time t602 of FIG. 6B is shorter than the time period from the time t501 to the time t502 of FIG. 6A, and the time period from the time t603 to the time t604 of FIG. 6B is shorter than the time period from the time t503 to the time t504 of FIG. 6A. If the time period from the time t601 to the time t602 and the time period from the time t603 to the time t604 are set at zero, the sustain pulse of FIG. 6B becomes the same pulse as the sustain pulse of FIG. 5B. In the sustain pulse of FIG. 6B, the time in which the high level Vs is kept and the time in which the low level (ground) is kept are the same as compared with the sustain pulse of FIG. 6A. The sustain pulse of FIG. 6B can make the pulse width small as compared with the sustain pulse of FIG. 6A, and therefore, can increase the average frequency per one frame image and can increase the number of pulses per one frame image. Thereby, when the display load rate is small, the peak luminance can be made higher. The sustain pulse of FIG. 6B rises rapidly as compared with the sustain pulse of FIG. 6A. Therefore, power supply to the Y electrode Yi is concentrated timewise at the time of sustain discharge, and the peak luminance is increased.

On the other hand, when the display load rate is large, the time period from t503 to t504 for recovering power and the time period from t501 to t502 for supplying the recovered power are made long, whereby the power recovery efficiency can be enhanced, and the power consumption can be reduced as the sustain pulse of FIG. 6A.

The clamp timing when the display load rate is smaller than the first threshold value (namely, when the timing of the clamp is early) does not have to be always constant in all the region in which the display load rate is smaller than the first threshold value. For example, in the range in which the display load rate does not exceed the first threshold value, the clamp timing may be gradually advanced in accordance with decrease in the display load rate. When the average frequency of the sustain pulse of display is changed as in the first embodiment, it is preferable to change the average frequency and the number of pulses gradually during the passage of a plurality of frames. It is preferable to change the average frequency and the number of pulses gradually within the passage of 60 frames, for example.

In the above description, the example of the timing t602 at which the potential of the capacitive load 420 is clamped to the high level Vs and the timing t604 at which the potential of the capacitive load 420 is clamped to the low level are advanced is explained, but the timing t604 at which it is clamped to the low level does not have to be always advanced, and only the timing t602 at which it is clamped to the high level may be advanced.

### Third Embodiment

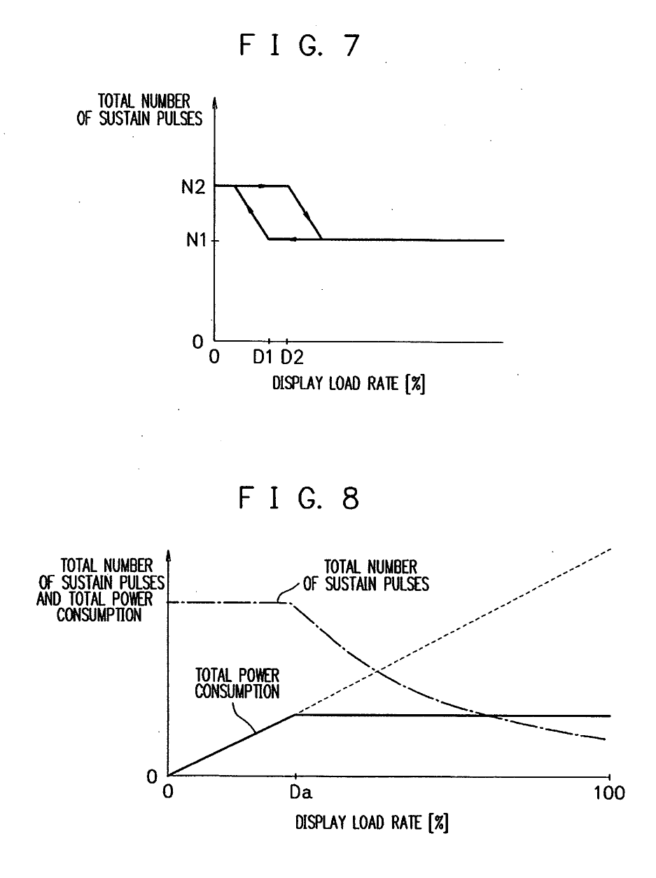

FIG. 7 is a graph showing the relationship between the display load rate and the total number of sustain pulses according to a third embodiment of the present invention. The horizontal axis represents the display load rate, whereas the vertical axis represents the total number of sustain pulses per one frame image. A total number N1 of sustain pulses is the total number of sustain pulses per one frame image of the sustain pulse of FIG. 5A or FIG. 6A when the display load rate is large. A total number N2 of sustain pulses is the total number of sustain pulses per one frame image of the sustain pulse of FIG. 5B or FIG. 6B when the display load rate is small, and is larger than the total number N1 of sustain pulses.

In the relationship of the display load rate and the total number of sustain pulses, the first threshold value D2 when the display load rate increases and the first threshold value D1 when the display load rate decreases have the hysteresis characteristics having different values.

When the display load rate increases, the sustain pulses of FIG. 5A or FIG. 6A are generated by the total number N1 of sustain pulses when the display load rate is larger than the threshold value D2, and when the display load rate is smaller than the threshold value D2, the sustain pulses of FIG. 5B or FIG. 6B are generated by the total number N2 of sustain pulses.

When the display load rate decreases, the sustain pulses of FIG. 5A or FIG. 6A are generated by the total number N1 of sustain pulses when the display load rate is larger than the threshold value D1, and when the display load rate is smaller than the threshold value D1, the sustain pulses of FIG. 5B or FIG. 6B are generated by the total number N2 of sustain pulses. The threshold value D1 is smaller than the threshold value D2.

As in the first and the second embodiments, when the total number of sustain pulses changes between N1 and N2, the average frequency and the total number of sustain pulses are gradually changed while passing through a plurality of frames.

If the threshold values D1 and D2 are set at the same value, when the display load rate frequently repeats a slight vertical change in the vicinity of the threshold value, the adverse effect of the total number of sustain pulses also frequently changing occurs. An adverse phenomenon such as so-called chattering occurs. By causing the threshold values D1 and D2 to differ from each other as in this embodiment, such an adverse effect can be prevented.

### Fourth Embodiment

FIG. 8 is a graph showing the relationship between the display load rate and the total power consumption, and the total number of sustain pulses according to a fourth embodiment of the present invention. The horizontal axis represents the display load rate, whereas the vertical axis represents the total power consumption or the total number of sustain pulses per one frame image.

If the total number of sustain pulses is constant irrespective of the display load rate, the total power consumption is proportional to the display load rate as shown by the dotted line in FIG. 8. If the display load rate becomes large, the number of display cells which light becomes large proportionally to the display load rate, and the discharge current increases. Therefore, the total power consumption also increases. However, when the total power consumption becomes large, a large amount of heat is generated, and the plasma display is likely to be broken. Thus, in order to suppress the total power consumption and heat generation amount, the total number of sustain pulses of the capacitive load 420 in one frame image is limited to become gradually small when the display load rate is larger than the second threshold value Da, as shown by the dashed line of FIG. 8. Thereby, the total number of sustain pulses lowers even if the number of display cells which light increases (namely, the display load rate rises) as shown by the solid line of FIG. 8, the total power consumption is suppressed to a constant value. The method is known as an automatic power control (APC), and in concrete, the X sustain circuit 103 and the Y sustain circuit 104 perform the control under the control of the sustain pulse control part 112 in FIG. 1.

As in the above description, when the display load rate becomes larger than the threshold value Da, the total number of sustain pulses is limited to decrease gradually, and therefore, the total number of sustain pulses cannot be changed in accordance with the display load rate, as shown in the above described first to third embodiments. Thus, on the occasion of decreasing the total number of sustain pulses when the display load rate is larger than the first threshold values D1 and D2 and increasing the total number of sustain pulses when the display load rate is smaller than the first threshold values D1 and D2 as in the first to the third embodiments, it is necessary to set the first threshold values D1 and D2 to be not larger than the second threshold value Da. The second threshold value Da is set at an arbitrary value in accordance with the characteristics of the panel, but in many of the present products, it is set at about 25%. In consideration of this, and in consideration of the upper limit of the total power consumption when the present invention is carried out, the first thresholds D1 and D2 are preferably not more than 20%, and are more preferably, not more than 5%.

As above, according to the first to the fourth embodiments, when the display load rate is larger than the first threshold value, the sustain pulse of FIG. 5A or FIG. 6A is generated. When the display load rate is smaller than the first threshold value, the sustain pulse of FIG. 5B or FIG. 6B is generated, and therefore, the sustain pulse width for display can be narrowed. Thereby, when the display load rate is smaller than the first threshold value, the number of sustain pulses for display is increased to be able to enhance luminance as compared with the case in which the display load rate is larger than the first threshold value.

In the above described first to the fourth embodiments, the control circuit unit 101 including the display load rate determining part 111 and the sustain pulse control part 112 in FIG. 1 may be configured by hardware, or may be configured by a microcomputer or the like executing software by a computer program. In the first to the fourth embodiments, the plasma display is described as an example, but the present invention is not limited to this, and can be applied to display apparatuses having capacitive loads. For example, the present invention can be applied to an organic EL (Electro Luminescence) display.

The above described present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

For example, the voltage value of the sustain pulse is explained with the Vs and the ground as examples, but the voltage value is not limited to them, and in the pulse mode in which the voltage value reciprocates between the positive potential and the negative potential (for example, the mode disclosed in Japanese Patent Application Laid-open No. 2002-62844), the present invention is also applicable.

### INDUSTRIAL APPLICABILITY

When the display load rate is smaller than the first threshold value, the power recovery circuit is not used, and the potential of the capacitive load is controlled by the clamp circuit, and therefore, the pulse width for display can be narrowed. Thereby, the number of pulses for display can be increased, and luminance can be enhanced.

What is claimed is:

1. A display apparatus, comprising:
a capacitive load;
clamp circuits which are for clamping a potential of said capacitive load to a high level and a low level;
power recovery circuits including coils which are for recovering power from said capacitive load and supplying the recovered power to said capacitive load;
a display load rate determining part which is for determining a display load rate; and
a control part which controls the potential of said capacitive load by said clamp circuits without using said power recovery circuits when the determined display load rate is smaller than a first threshold value, and controls the potential of said capacitive load by said power recovery circuits and said clamp circuits when the determined display load rate is larger than the first threshold value.

2. The display apparatus according to claim 1, wherein said control part limits a total number of sustain pulses of said capacitive load in one frame image when the display load rate is larger than a second threshold value, and the first threshold value is not larger than the second threshold value.

3. The display apparatus according to claim 1, wherein the first threshold value when the display load rate increases, and the first threshold value when the display load rate decreases are different values.

4. The display apparatus according to claim 1, wherein the first threshold value of the display load rate is not more than 20%.

5. The display apparatus according to claim 4, wherein the first threshold value of the display load rate is not more than 5%.

6. The display apparatus according to claim 1, wherein said control part increases an average frequency per one frame image, of a pulse for display which is supplied to said capacitive load when the display load rate is smaller than the first threshold value, as compared with a time when the display load rate is larger than the first threshold value.

7. The display apparatus according to claim 6, wherein said control part increases a number of pulses for display per one frame image when the display load rate is smaller than the first threshold value, as compared with the time when the display load rate is larger than the first threshold value.

8. The display apparatus according to claim 6, wherein said control part gradually changes the average frequency during passage of a plurality of frames when changing the average frequency of the pulse for display.

9. The display apparatus according to claim 8,
wherein said control part gradually changes the average frequency within passage of 60 frames when changing the average frequency of the pulse for display.

10. The display apparatus according to claim 1, wherein said control part generates a pulse by clamping the potential of said capacitive load to a high level and a low level without performing power recovery of said capacitive load when the determined display load rate is smaller than the first threshold value, and generates a pulse by recovering the power of said capacitive load, clamping the potential of said capacitive load to the low level, supplying the recovered power to said capacitive load, and clamping the potential of said capacitive load to the high level when the determined display load rate is larger than the first threshold value.

11. A method for driving a display apparatus, comprising:
a display load rate determining step of determining a display load rate; and
a control step of generating a pulse by clamping a potential of a capacitive load to a high level and a low level without recovering power of the capacitive load when the determined display load rate is smaller than the first threshold value, and generating a pulse by recovering the power of the capacitive load, clamping the potential of the capacitive load to the low level, supplying the recovered power to the capacitive load, and clamping the potential of the capacitive load to the high level when the determined display load rate is larger than the first threshold value.

12. A display apparatus, comprising:
a capacitive load;
clamp circuits which are for clamping a potential of said capacitive load to a high level and a low level;
power recovery circuits including coils which are for recovering power from said capacitive load and supplying the recovered power to said capacitive load;
a display load rate determining part which is for determining a display load rate; and
a control part which causes timing at which the control part clamps the potential of said capacitive load to the high level to differ when the determined display load rate is smaller than the first threshold value and when it is larger than the first threshold value when generating a pulse by recovering the power of said capacitive load, clamping the potential of said capacitive load to the low level, supplying the recovered power to said capacitive load, and clamping the potential of said capacitive load to the high level.

13. The display apparatus according to claim 12, wherein said control part advances the timing at which it clamps the potential of said capacitive load to the high level when the determined display load rate is smaller than the first threshold value, as compared with the time when the determined display load rate is larger than the first threshold value.

14. The display apparatus according to claim 13, wherein said control part gradually advances the timing at which the control part clamps the potential of said capacitive load to the high level in correspondence to a decrease of the display load rate, in at least a part of a region where the determined display load rate is smaller than the first threshold value.

15. The display apparatus according to claim 13, wherein said control part limits a total number of sustain pulses of said capacitive load in one frame image when the display load rate is larger than a second threshold value, and the first threshold value is not larger than the second threshold value.

16. The display apparatus according to claim 13, wherein the first threshold value when the display load rate increases and the first threshold value when the display load rate decreases are different values.

17. The display apparatus according to claim 13, wherein the first threshold value of the display load rate is not more than 20%.

18. The display apparatus according to claim 17, wherein the first threshold value of the display load rate is not more than 5%.

19. The display apparatus according to claim 13, wherein said control part increases an average frequency per one frame image of, a pulse for display which is supplied to said capacitive load when the display load rate is smaller than the first threshold value, as compare with a time when the display load rate is larger than the first threshold value.

20. The display apparatus according to claim 19, wherein said control part increases the number of pulses for display per one frame image when the display load rate is smaller than the first threshold value, as compared with the time when the display load rate is larger than the first threshold value.

21. The display apparatus according to claim 19, wherein said control part gradually changes the average frequency during passage of a plurality of frames when changing the average frequency of the pulse for display.

22. The display apparatus according to claim 21, wherein said control part gradually changes the average frequency within passage of 60 frames when changing the average frequency of the pulse for display.

23. The display apparatus according to claim 12, wherein said control part causes timing at which said control part clamps the potential of said capacitive load to the low level to differ in accordance with the determined display load rate.

24. A method for driving a display apparatus, comprising:
a display load rate determining step of determining a display load rate; and
a control step of causing timing of clamping a potential of a capacitive load to a high level to differ when the determined display load is smaller than a first threshold value and when the determined display load is larger than the first threshold value, when generating a pulse by recovering power of the capacitive load, clamping the potential of the capacitive load to a low level, supplying the recovered power to the capacitive load, and clamping the potential of the capacitive load to the high level.
